(19) United States
(12) Patent Application Publication
(10) Pub. No.: US 2025/0040485 A1
(43) Pub. Date: Feb. 6, 2025

(54) Push Mower Lawn Striping Attachment Device

(71) Applicant: Stephen Wunschel, West Des Moines, IA (US)

(72) Inventor: Stephen Wunschel, West Des Moines, IA (US)

(21) Appl. No.: 18/641,624

(22) Filed: Apr. 22, 2024

Related U.S. Application Data
(60) Provisional application No. 63/517,466, filed on Aug. 3, 2023.

(51) Int. Cl. A01D 43/00

(52) U.S. Cl. CPC A01D 43/00

(57) ABSTRACT

A push mower lawn striping attachment device is provided. The device is comprised of a frame that can be attached to a push lawnmower, between the two rear wheels of the mower, via at least one fastener. The frame has at least one bristle that extends downwards from the frame. As a result, the bristle brushes blades of grass in the same or opposite direction of the push mower in order to create a striping pattern in the grass.

### CROSS-REFERENCE TO RELATED APPLICATION

The present application claims priority to, and the benefit of, U.S. Provisional Application No. 63/517,466, which was filed on Aug. 3, 2023, and is incorporated herein by reference in its entirety.

### FIELD OF THE INVENTION

The present invention relates generally to the field of lawnmowers. More specifically, the present invention relates to a push mower lawn stripping attachment device that can be removably attached to a push lawnmower to create striping in the grass when the push mower is used to cut grass. Accordingly, the present disclosure makes specific reference thereto. Nonetheless, it is to be appreciated that aspects of the present invention are also equally applicable to other like applications, devices, and methods of manufacture.

### BACKGROUND

Many individuals desire striping in their lawn grass, as it can provide an aesthetically pleasing pattern to the yard and add a touch of professionalism reminiscent of sports fields or golf courses. These lawn enthusiasts take great pride in the appearance of their lawn and see striping as a way to distinguish their yard from others. However, achieving a striped look often requires the use of lawn stripers, which can present several challenges to homeowners.

Existing lawn stripers on the market tend to be bulky, adding weight and unwieldiness to lawnmowers. They may not easily attach to all models of lawnmowers, requiring extra effort to secure them. This often leads to time-consuming installation processes that can be frustrating and discouraging, especially for those who are not mechanically inclined.

In addition, once attached, bulky stripers can make the lawnmower harder to maneuver, particularly in small or irregularly shaped yards. This can result in uneven stripes or difficulty navigating around landscaping features. As a result, homeowners may find themselves struggling to achieve the desired striped effect and instead, becoming frustrated with the process. The added complexity and difficulty of using these existing lawn stripers can deter many individuals from pursuing lawn striping, despite their desire for a beautifully patterned lawn.

Therefore, there exists a long-felt need in the art for an improved lawn striping device. There also exists a long-felt need in the art for a push mower lawn striping attachment device. More specifically, there exists a long-felt need in the art for a push mower lawn striping attachment device that can easily attach to a push mower. In addition, there exists a long-felt need in the art for a push mower lawn striping attachment device that can easily attach to a push mower wherein the device is not bulky and does not make a push mower unwieldy.

The subject matter disclosed and claimed herein, in one embodiment thereof, comprises a push mower lawn striping attachment device. The device is comprised of a frame that can be attached to a push lawnmower, between the two rear wheels, via at least one fastener such as, but not limited to, a clip. The frame has at least one bristle that extends downwards from the frame. As a result, the bristle brushes blades of grass in the same or opposite direction of the push mower in order to create a striping pattern in the grass.

In this manner, the push mower lawn striping attachment device of the present invention accomplishes all the foregoing objectives and provides an improved lawn striping device. More specifically, the device can easily attach to a push mower. Further, the device is not bulky and does not make a push mower unwieldy.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a push mower lawn striping attachment device comprised of a frame, at least one fastener and at least one bristle. The frame can be easily attached to the body of a lawnmower via at least one fastener of the frame, wherein the bristle creates striping in the grass.

More specifically, at least one bristle extends downwards from a bottom surface of the frame. In one embodiment, the bristle is made from a natural material or a synthetic bristle material. While the mower is pushed, the bristle pushes blades of grass in the same or opposite direction of the mower during mowing to create striping.

The frame is comprised of at least one fastener that allows the frame to be easily attached to the body of a lawnmower. Preferably, the frame is attached at the rear of the body between the rear wheels of the mower. The fastener is preferably a clip or a clamp to allow the device to be quickly attached or detached from the mower as desired.

The present invention is also comprised of a method of using the device. First, a device is provided comprised of a frame comprised of at least one bristle and at least one fastener. Then, the fastener can be used to position the device on the body of a lawnmower. The device is preferably positioned on the rear of the body, between the two rear wheels of the mower. Next, the mower can be used to mow grass wherein the bristle brushes the blades of the grass in the same or opposite direction as the direction the mower is traveling to create lawn striping.

The present invention is also comprised of a second method of using the device. First, a device is provided comprised of a frame comprised of at least one fastener and at least one attachment fastener, and a secondary frame comprised of at least one bristle and at least one attachment fastener. Then, the secondary frame can be attached to the frame via attaching the fasteners. Then, the fastener can be used to position the device on the body of a lawnmower. The device is preferably positioned on the rear of the body, between the two rear wheels of the mower. Next, the mower can be used to mow grass wherein the bristle brushes the blades of the grass in the same or opposite direction as the direction the mower is traveling to create lawn striping.

Accordingly, the push mower lawn striping attachment device of the present invention is particularly advantageous as it provides an improved lawn striping device. More specifically, the device can easily attach to a push mower. Further, the device is not bulky and does not make a push mower unwieldy. In this manner, the push mower lawn striping attachment device overcomes the limitations of existing lawn striping devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a push mower lawn striping attachment device of the present invention in accordance with the disclosed architecture;

FIG. 2 illustrates a rear perspective view of one potential embodiment of a push mower lawn striping attachment device of the present invention while attached to a lawnmower in accordance with the disclosed architecture;

FIG. 3 illustrates a side view of one potential embodiment of a push mower lawn striping attachment device of the present invention in accordance with the disclosed architecture;

FIG. 4 illustrates a flowchart of a method of using one potential embodiment of a push mower lawn striping attachment device of the present invention in accordance with the disclosed architecture; and

FIG. 5 illustrates a flowchart of a method of using one potential embodiment of a push mower lawn striping attachment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved lawn striping device. There also exists a long-felt need in the art for a push mower lawn striping attachment device. More specifically, there exists a long-felt need in the art for a push mower lawn striping attachment device that can easily attach to a push mower. In addition, there exists a long-felt need in the art for a push mower lawn striping attachment device that can easily attach to a push mower wherein the device is not bulky and does not make a push mower unwieldy.

The present invention, in one exemplary embodiment, is comprised of a push mower lawn striping attachment device. The device is comprised of a frame, at least one fastener and at least one bristle. The frame can be easily attached to the body of a lawnmower via at least one fastener of the frame, wherein the bristle creates striping in grass.

More specifically, at least one bristle extends downwards from a bottom surface of the frame. In one embodiment, the bristle is made from a natural material or a synthetic bristle material. While the mower is pushed, the bristle pushes blades of grass in the same or opposite direction of the mower during mowing to create striping.

The frame is comprised of at least one fastener. The fastener allows the frame to be easily attached to the body of a lawnmower. The frame is preferably attached at the rear of the body between the rear wheels of the mower. The fastener is preferably a clip or a clamp to allow the device to be quickly attached or detached from the mower as desired.

The present invention is also comprised of a method of using the device. First, a device is provided comprised of a frame comprised of at least one bristle and at least one fastener. Then, the fastener can be used to position the device on the body of a lawnmower. The device is preferably positioned on the rear of the body, between the two rear wheels of the mower. Next, the mower can be used to mow grass wherein the bristle brushes the blades of the grass in the same or opposite direction as the direction the mower is traveling to create lawn striping.

The present invention is also comprised of a second method of using the device. First, a device is provided comprised of a frame comprised of at least one fastener and at least one attachment fastener, and a secondary frame comprised of at least one bristle and at least one attachment fastener. Then, the secondary frame can be attached to the frame via attaching the fasteners. Then, the fastener can be used to position the device on the body of a lawnmower. The device is preferably positioned on the rear of the body, between the two rear wheels of the mower. Next, the mower can be used to mow grass, wherein the bristle brushes the blades of the grass in the same or opposite direction as the direction the mower is traveling to create lawn striping.

Accordingly, the push mower lawn striping attachment device of the present invention is particularly advantageous as it provides an improved lawn striping device. More specifically, the device can easily attach to a push mower. Further, the device is not bulky and does not make a push mower unwieldy. In this manner, the push mower lawn striping attachment device overcomes the limitations of existing lawn striping devices known in the art.

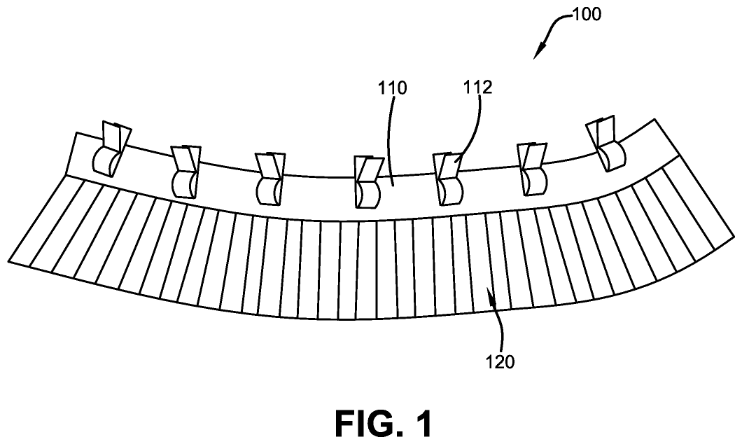

Referring initially to the drawings, FIG. 1 illustrates a front view of one potential embodiment of a push mower lawn striping attachment device 100 of the present invention in accordance with the disclosed architecture. The device 100 is comprised of at least one frame 110 with at least one fastener 112 and at least one bristle 120. The frame 110 can be easily attached to the body 12 of a lawnmower 10 via at least one fastener 112 of the frame 110.

The frame 110 can be straight or curved in various embodiments to follow the contour of a body 12 of a lawnmower 10. In order to further follow the contour of the body 12 of the lawnmower 10, the frame 110 may be made from a flexible (or rigid) material. Said material includes (but is not limited to) aluminum, stainless steel, UV-resistant plastic, etc.

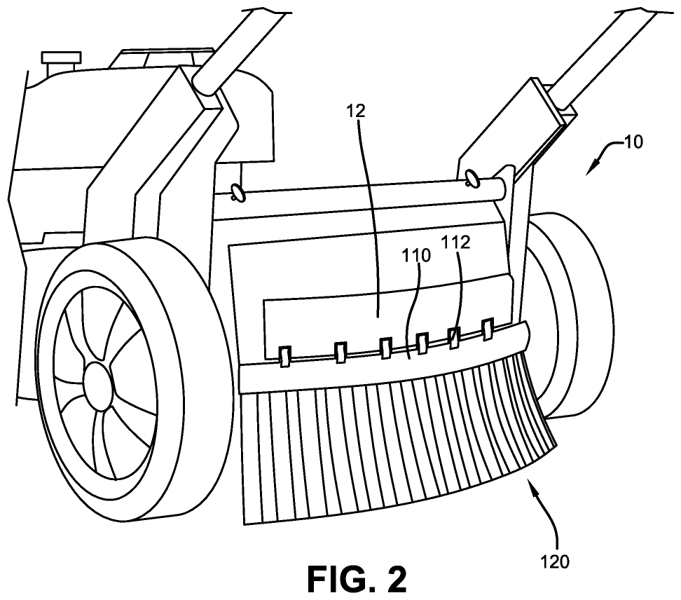

The frame 110 is comprised of at least one fastener 112. The fastener 112 allows the frame 110 to be easily attached to the body 12 of a lawnmower 10. Preferably, the frame 110 is attached at the rear of the body 12 between the rear wheels of the mower 10, as seen in FIG. 2. The fastener 112 is preferably a clip or a clamp to allow the device 100 to be quickly attached or detached from the mower 10 as desired. However, the fastener 112 may also include, but is not limited to, a magnet, a screw, a bolt, an adhesive, a snap button fastener, etc.

At least one bristle 120 extends downwards from a bottom surface 116 of the frame 110. In one embodiment, the bristle 120 is made from a natural material such as, but not limited to, animal hair. In another embodiment, the bristle 120 is made from a synthetic bristle material. The bristle 120 may be any style and size of bristle material and may be arranged in any orientation on the frame 110 to produce any pattern on a grass surface via the bristle 120 pushing blades of grass in the same or opposite direction of the mower 10 during mowing. In one embodiment, the bristle 120 is a solid, continuous piece of rubber or other material.

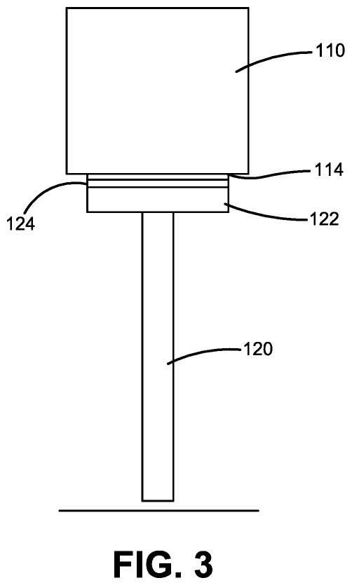

In one embodiment, the bristles 120 may fixedly attach to the bottom surface 116 of the frame 110. In another embodiment, the bristles 120 fixedly attach to a frame 122, wherein the frame 122 removably attaches to the frame 110. This embodiment, as seen in FIG. 3 allows the bristles 120 to be easily changed as desired (to achieve different patterns) or once they become worn. Both frames 110,122 are preferably comprised of at least one fastener 114, 124. The fasteners 114,124 allow the frames 110,122 to removably attach to one another. The fasteners 114,124 may be any reciprocating fastener type known in the art such as, but not limited to, hook and loop, magnets, tongue and groove, male and female, etc.

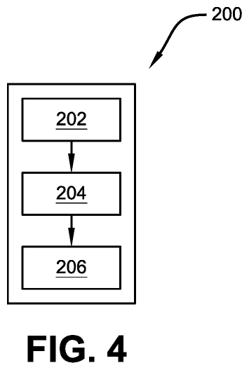

The present invention is also comprised of a method of using 200 the device 100, as seen in FIG. 4. First, a device 100 is provided comprised of a frame 110 comprised of at least one bristle 120 and at least one fastener 112 [Step 202]. Then, the fastener 112 can be used to position and attach the device 100 on the body 12 of a lawnmower 10 [Step 204]. The device 100 is preferably positioned on the rear of the body 12, between the two rear wheels of the mower 10. Next, the mower 10 can be used to mow grass, wherein the bristle 120 brushes the blades of the grass in the same or opposite direction as the direction the mower 10 is traveling to create lawn striping [Step 206].

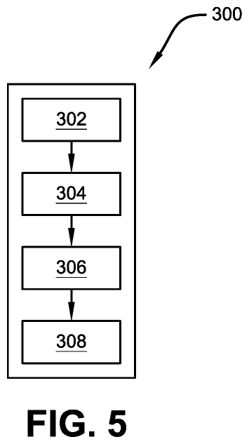

The present invention is also comprised of a second method of using 300 the device 100, as seen in FIG. 5. First, a device 100 is provided comprised of a frame 110 comprised of at least one fastener 112 and at least one attachment fastener 114, and a secondary frame 122 comprised of at least one bristle 120 and at least one attachment fastener 124 [Step 302]. Then, the secondary frame 122 can be attached to the frame 110 via attaching the fasteners 114,124 [Step 304]. Then, the fastener 112 can be used to position the device 100 on the body 12 of a lawnmower 10 [Step 306]. The device 100 is preferably positioned on the rear of the body 12, between the two rear wheels of the mower 10. Next, the mower 10 can be used to mow grass, wherein the bristle 120 brushes the blades of the grass in the same or opposite direction as the direction the mower 10 is traveling to create lawn striping [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “push mower lawn striping attachment device” and “device” are interchangeable and refer to the push mower lawn striping attachment device 100 of the present invention.

Notwithstanding the foregoing, the push mower lawn striping attachment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the push mower lawn striping attachment device 100 as shown in the FIGS. are for illustrative purposes only, and that many other sizes and shapes of the push mower lawn striping attachment device 100 are well within the scope of the present disclosure. Although the dimensions of the push mower lawn striping attachment device 100 are important design parameters for user convenience, the push mower lawn striping attachment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A push mower lawn striping attachment device comprising:
a frame;
a bristle positioned on the frame; and
a fastener.

2. The push mower lawn striping attachment device of claim 1, wherein the frame is made of a flexible material.

3. The push mower lawn striping attachment device of claim 1, wherein the bristle is comprised of a natural material.

4. The push mower lawn striping attachment device of claim 1, wherein the fastener is comprised of a clip.

5. The push mower lawn striping attachment device of claim 1, wherein the fastener is comprised of a clamp.

6. The push mower lawn striping attachment device of claim 1, wherein the fastener is comprised of a magnet, a screw, a bolt, an adhesive, or a snap button fastener.

7. A push mower lawn striping attachment device comprising:
a frame comprised of a first fastener and a second fastener; and
a bristle comprised of a bristle frame.

8. The push mower lawn striping attachment device of claim 7, wherein the frame is comprised of a rigid material.

9. The push mower lawn striping attachment device of claim 7, wherein the bristle is comprised of a synthetic material.

10. The push mower lawn striping attachment device of claim 9, wherein the bristle is comprised of a rubber material.

11. The push mower lawn striping attachment device of claim 7, wherein the bristle frame is comprised of a third fastener that attaches to the second fastener.

12. The push mower lawn striping attachment device of claim 11, wherein the third fastener is comprised of a hook fastener, a loop fastener, a magnet fastener, a tongue fastener, a groove fastener, a male fastener, or a female fastener.

13. The push mower lawn striping attachment device of claim 7, wherein the second fastener is comprised of a hook fastener, a loop fastener, a magnet fastener, a tongue fastener, a groove fastener, a male fastener, or a female fastener.

14. The push mower lawn striping attachment device of claim 7, wherein the first fastener is comprised of a clip.

15. The push mower lawn striping attachment device of claim 7, wherein the first fastener is comprised of a clamp.

16. The push mower lawn striping attachment device of claim 7, wherein the first fastener is comprised of a magnet, a screw, a bolt, an adhesive, or a snap button fastener.

17. A method of using a push mower lawn striping attachment device, the method comprising the following steps:
providing a push mower lawn striping attachment device comprised of a frame, a bristle, and a fastener;
attaching the frame to a body of a push lawnmower via the fastener between a first rear wheel and a second rear wheel of the push lawnmower;
using the push lawnmower to mow grass.

18. The method of using a push mower lawn striping attachment device of claim 17, wherein the bristle extends downward from the frame.

19. The method of using a push mower lawn striping attachment device of claim 17, wherein the fastener is comprised of a clip or a clamp.

20. The method of using a push mower lawn striping attachment device of claim 17, wherein the bristle removably attaches to the frame.
